(19) United States
(12) Patent Application Publication
(10) Pub. No.: US 2016/0231413 A1
(43) Pub. Date: Aug. 11, 2016

(54) APPARATUS AND METHOD OF ESTIMATING POSITION IN COMMUNICATION SYSTEM

(71) Applicant: Samsung Electronics Co., Ltd., Gyeonggi-do (KR)

(72) Inventors: Andrey ZOBENKO, Gyeonggi-do (KR); Soo-Yong KIM, Gyeonggi-do (KR); Chae-Hag YI, Gyeonggi-do (KR)

(73) Assignee: Samsung Electronics Co., Ltd.

(21) Appl. No.: 14/750,465

(22) Filed: Jun. 25, 2015

(30) Foreign Application Priority Data
Feb. 11, 2015 (KR) 10-2015-0021104
Mar. 18, 2015 (KR) 10-2015-0037547

(51) Int. Cl. G01S 5/02; G01S 3/28

(52) U.S. Cl. CPC G01S 5/0205; G01S 3/28

(57) ABSTRACT

A receiver apparatus, a receiver method, a transmitter apparatus, a transmitter method, and a chipset for estimating a position of a terminal in a communication system are provided. The receiver apparatus includes a receiver configured to receive signals transmitted from two or more antennas which are in an Access Point (AP) and have radial directions which are different from each other; and a controller configured to determine signal levels with respect to the respective two or more antennas from signal strength values of signals which are distinguished by the received radial directions which are different from each other, estimate a direction and distance between the AP and the terminal on the basis of the determined signal levels, and determine the position of the terminal from the estimated direction and distance.

### PRIORITY

This application claims priority under 35 U.S.C. §119(a) to a Korean Patent Application filed on Feb. 11, 2015 in the Korean Intellectual Property Office and assigned Serial No. 10-2015-0021104, and to a Korean Patent Application filed on Mar. 18, 2015 in the Korean Intellectual Property Office and assigned Serial No. 10-2015-0037547, the entire contents of each of which are incorporated herein by reference.

### BACKGROUND

1. Field of the Disclosure

The present disclosure relates to an apparatus and method of estimating a position of a terminal in a communication system, and more particularly, to an apparatus and method of estimating a position of a terminal in a communication system by using signal strengths with respect to each of a plurality of antennas included in one Access Point (AP).

2. Description of the Related Art

A radio based positioning system can be implemented using a Wireless LAN (WLAN), Wireless Fidelity (Wi-Fi), Wireless Broadband Internet (WiBro), World interoperability for Microwave Access (WiMAX), High Speed Downlink Packet Access (HSDPA), ZigBee, Bluetooth, Ultra-WideBand (UWB), Long Term Evolution (LTE), and the like which are commonly used.

In general, the position estimation methods in a radio based positioning system use a signal transmission and reception between an AP and a terminal attempting to estimate a position. When a signal is transmitted and received between an AP and a terminal, an error occurs between the estimated position and the actual position of the terminal due to an interference signal between antennas in the AP. Accordingly, when there is a plurality of antennas included in the AP in a communication system, there is a need for a method that can efficiently estimate a position of a terminal.

### SUMMARY

An aspect of the present disclosure provides an apparatus and method of estimating a position of a terminal in a communication system.

Another aspect of the present disclosure provides an apparatus and method of estimating a position of a terminal in a communication system by using signal strengths with respect to each of a plurality of antennas included in one AP.

In accordance with an aspect of the present disclosure, an apparatus for estimating a position of a terminal in a communication system is provided. The apparatus includes a receiver configured to receive signals transmitted from two or more antennas which are included in an Access Point (AP) and have radial directions which are different from each other; and a controller configured to determine signal levels with respect to the respective two or more antennas from signal strength values of signals which are distinguished by the received radial directions which are different from each other, estimate a direction and distance between the AP and the terminal on the basis of the determined signal levels, and determine the position of the terminal from the estimated direction and distance.

In accordance with another aspect of the present disclosure, a method of estimating a position of a terminal in a communication system is provided. The method includes receiving signals transmitted from two or more antennas which are included in an AP and have radial directions which are different from each other; determining signal levels with respect to the respective two or more antennas from signal strength values of the signals which are distinguished by the received radial directions which are different from each other; estimating a direction and distance between the AP and the terminal based on the determined signal levels; and determining the position of the terminal from the estimated direction and distance.

In accordance with another aspect of the present disclosure, a chipset for estimating a position of a terminal in a communication system is provided. The chipset is configured to receive signals transmitted from two or more antennas which are included in an AP and have radial directions which are different from each other; determine signal levels with respect to the respective two or more antennas from signal strength values of the signals which are distinguished by the received radial directions which are different from each other; estimate a direction and distance between the AP and the terminal based on the determined signal levels; and determine the position of the terminal from the estimated direction and distance.

A communication system of the present disclosure includes an AP including a plurality of antennas and a terminal to communicate with the AP. The terminal receives signals for estimating positions from each of the plurality of antennas in the AP, which have radial directions which are different from each other. Each of the plurality of antennas in the AP can transmit and receive signals to/from the terminal with different directivity diagrams. In addition, each of the plurality of antennas may indicate a directivity diagram different from each other.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is an illustration of a communication system to which the present disclosure is applied;

FIG. 2 is an illustration of antenna diagrams to which an embodiment of the present disclosure is applied;

FIG. 3 is an illustration of signal strengths of signals received based on a position of a terminal in a communication system according to an embodiment of the present disclosure;

FIG. 4 is a block diagram of a position estimation apparatus for estimating a position by a terminal in a communication system according to an embodiment of the present disclosure;

FIGS. 5 and 6A-6B are illustrations of a directivity diagram of respective antennas in a communication system according to an embodiment of the present disclosure;

FIGS. 7A-7C are illustrations of calculating, by a position estimation unit, a quadrant where a terminal is located according to an embodiment of the present disclosure; and

FIG. 8 is a flowchart of a position estimation method by a terminal in a communication system according to an embodiment of the present disclosure.

### DETAILED DESCRIPTION OF EMBODIMENTS OF THE PRESENT DISCLOSURE

The present disclosure concerns, when there is a plurality of antennas in an AP in a communication system, estimating a position by a terminal based on signal strengths of signals transmitted from each of a plurality of antennas which have radial directions which are different from each other. In this case, the position of the terminal relates to a distance and direction between the terminal and the AP.

To this end, a position estimation apparatus and method in a communication system according to an embodiment of the present disclosure is described below in detail. Hereinafter, the embodiment of the present disclosure is described using an example where antennas for an AP in a communication system have three or four radial directions which are different from each other. However, the present disclosure is also applicable to all communication systems where antennas for an AP have two or more radial directions which are different from each other.

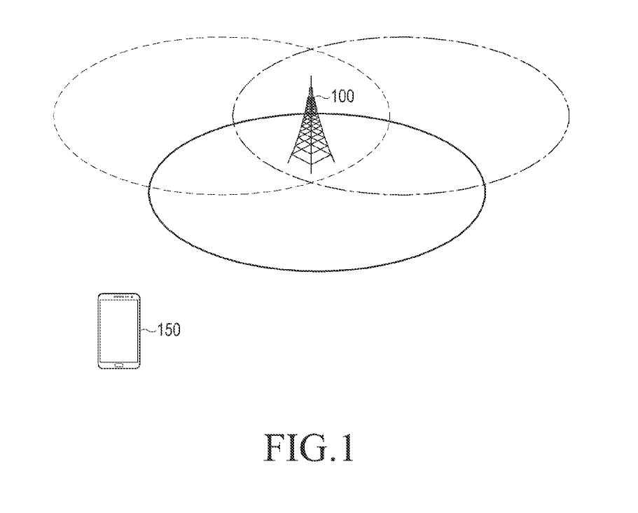

FIG. 1 is an illustration of a communication system to which the present disclosure is applied.

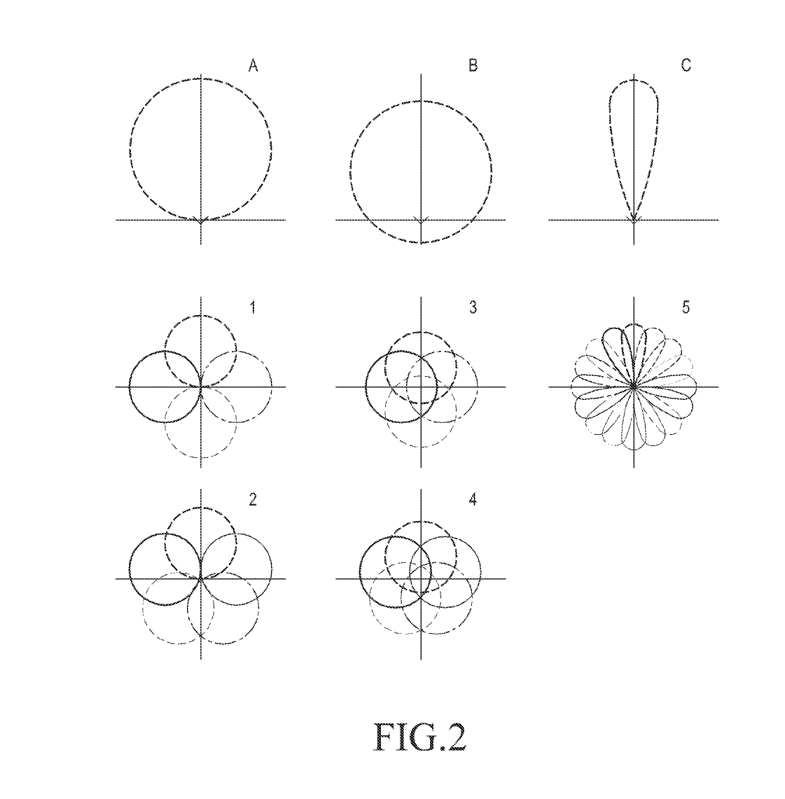

Referring to FIG. 1, the communication system includes an AP 100 including a plurality of antennas and a terminal 150 to communicate with the AP 100. The terminal 150 receives signals for estimating positions from each of the plurality of antennas in the AP 100, which have radial directions which are different from each other. In this case, each of the plurality of antennas in the AP 100 can transmit and receive signals to/from the terminal 150 with different directivity diagrams. In addition, each of the plurality of antennas, as shown in FIG. 2, may indicate a directivity diagram different from each other.

FIG. 2 is an illustration of antenna diagrams to which an embodiment of the present disclosure is applied.

Referring to FIG. 2, as shown in A and C, when a first antenna indicates an antenna diagram passing through the origin of a quadrant, each of the plurality of antennas included in an AP may indicate antenna diagrams having radial directions such as Nos. 1, 2, and 5. Meanwhile, as shown in B, when the first antenna indicates an antenna diagram that does not pass through the origin of a quadrant, each of the plurality of antennas may indicate an antenna diagram which has radial directions such as Nos. 3 and 4.

Accordingly, the terminal 150 receives, from each of the plurality of antennas, signals having different signal strength, according to the distance and direction of the terminal 150 and each of the plurality of antennas.

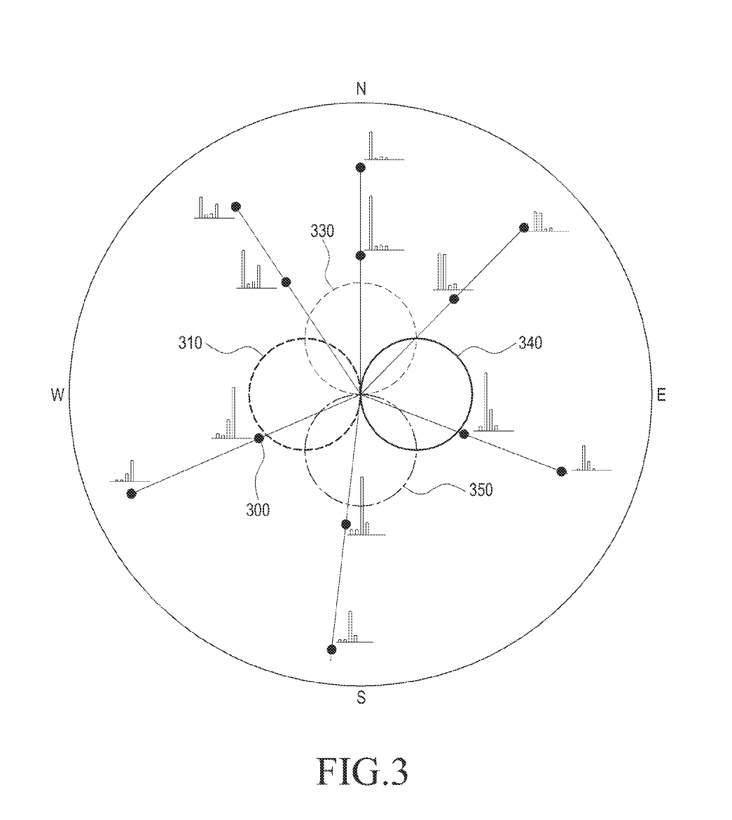

As an example, the terminal 150, as shown in FIG. 3, may receive signals having different signal strengths, from each of the antennas having a plurality of radial directions which are different from each other according to the position of the terminal 150.

FIG. 3 shows signal levels according to the Received Signal Strength Index (RSSI) of signals received based on the position of the terminal in a communication system according to an embodiment of the present disclosure. FIG. 3 shows an AP including four antennas.

Referring to FIG. 3, when the terminal 150 is located at the positions indicated by the black dots, the terminal 150 determines signal levels of a plurality of antennas from the RSSIs of the signals received from a plurality of antennas. In this case, the signal levels of the plurality of antennas are determined from the value of the relative difference between the antennas that have radial directions which are different from each other.

As an example, when the terminal 150 is located in a dot corresponding to the reference numeral 300, the terminal 150 receives the strongest signal from a first antenna 310, receives the second strongest signal from a fourth antenna 350, receives a signal with the third strongest from a second antenna 330, and receives a signal with the weakest strength from a third antenna 340. Then, the terminal 150 identifies the RSSIs of the signals received from the first to fourth antennas 310, 330, 340, and 350, and determines the value of the relative difference between the identified RSSIs as a signal level. Accordingly, an embodiment of the present disclosure determines a signal level on the basis of the RSSIs of the signals received from a plurality of antennas, and estimates the position of the terminal 150 using the level of the determined signal.

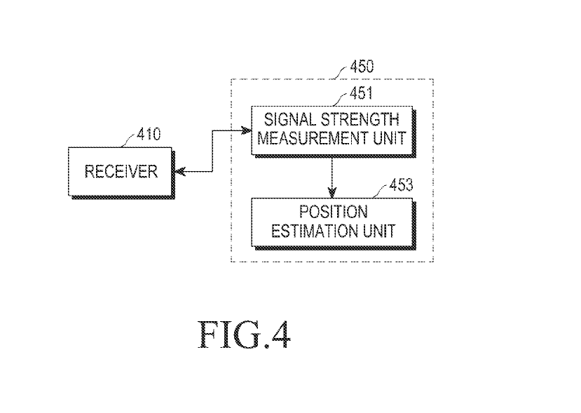

FIG. 4 is a block diagram of a position estimation apparatus for estimating a position by a terminal of a communication system according to an embodiment of the present disclosure.

Referring to FIG. 4, the position estimation apparatus includes a receiver 410 and a controller 450, where the controller 450 includes a signal strength measurement unit 451 and a position estimation unit 453.

The receiver 410 receives signals for estimating position which are transmitted from each of a plurality of antennas in an AP, where the antennas have radial directions which are different from each other.

Further, the signal strength measurement unit 451 identifies the RSSIs of the signals received from each of the plurality of antennas. Furthermore, the signal strength measurement unit 451, on the basis of the RSSIs of each of the plurality of antennas which has been identified, determines the signal level at the antennas.

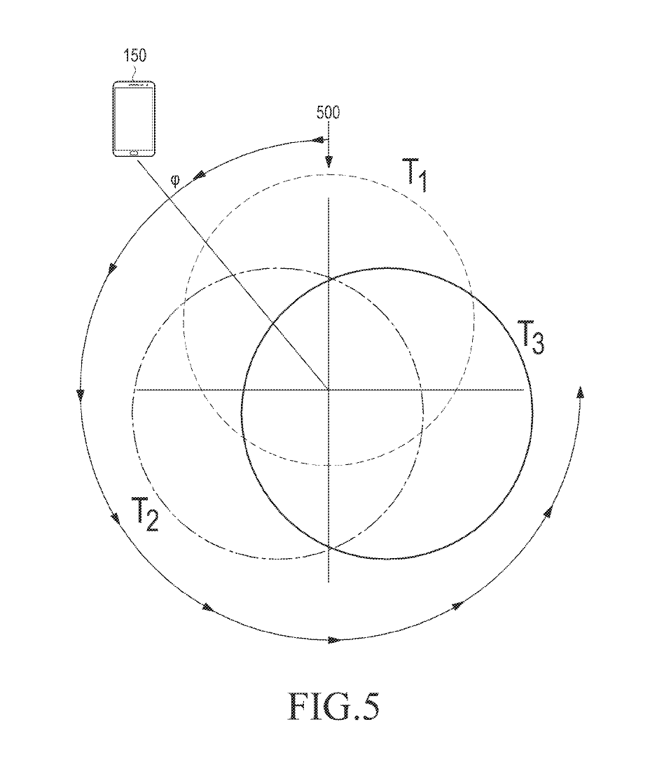

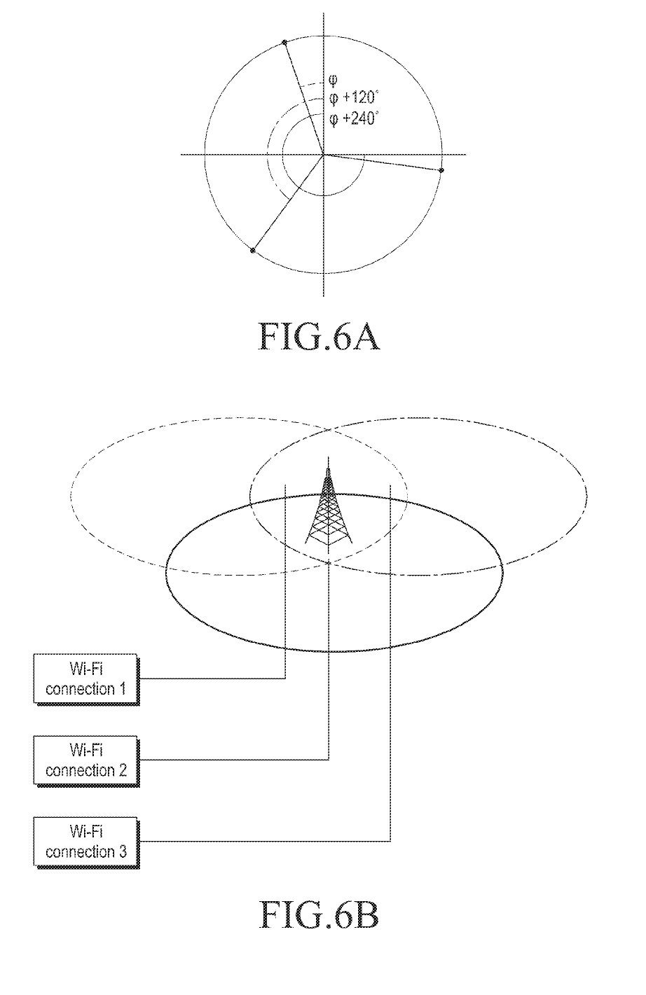

In detail, the signal strength measurement unit 451 determines the signal levels of the antennas using FIGS. 5, 6A, and 6B, and the equations described below.

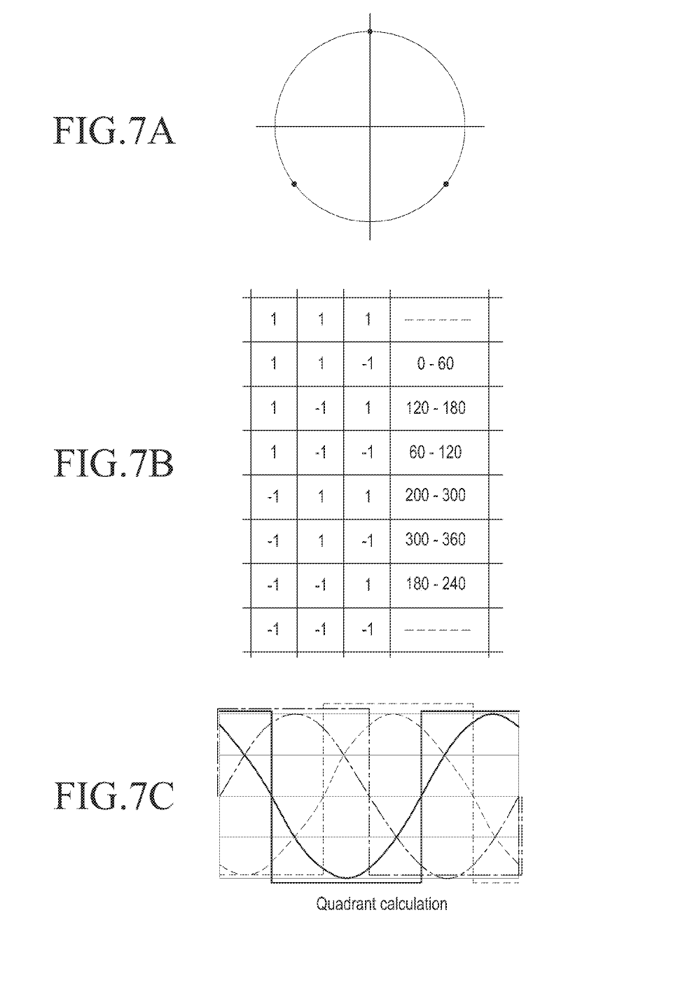

FIGS. 6A, 6B, and 7A-7C illustrate directivity diagrams of respective antennas in a communication system according to an embodiment of the present disclosure.

When it is assumed that a point corresponding to a reference numeral 500 in FIG. 5 corresponds to an initial point (that is, 0 degrees) for estimating an angle of a signal received by a terminal 150, based on the reference numeral 500, a first antenna T1, a second antenna T2, and a third antenna T3 each have an angle PHI from the position of the terminal 150, respectively. Accordingly, the signal strength measurement unit 451 determines the signal level by using the relative value of the angles for the first antenna T1, the second antenna T2, and the third antenna, respectively.

Further, referring to FIGS. 6A and 6B, it can be determined that the first antenna T1, the second antenna T2 and the third antenna T3 each have a different angle, respectively.

On the basis of FIGS. 5, 6A, and 6B, each of the radiuses of the first antenna T1, the second antenna T2, and the third antenna T3 can be estimated by Equation (1) as follows:

$$\{ \begin{matrix}{T}_{1} = {T}_{0} ( 1 + K sin ( φ ) ) \\ {T}_{2} = {T}_{0} ( 1 + K sin ( φ + \frac{2 π}{3} ) ) \\ {T}_{3} = {T}_{0} ( 1 + K sin ( φ + \frac{4 π}{3} ) )\end{matrix} \qquad ( 1 )$$

In this case, T0 is the strength of the signal output from the AP, K is a coefficient determined in advance by each antenna and has a value corresponding to 0≦K≦1. When there is N number of antennas, Equation (1) above can be generalized by Equation (2) as follows:

$${T}_{n} = {T}_{0} \{ 1 + K sin ( ∅ + \frac{2 ( n - 1 ) π}{N} ) \} , \\ n = 1 , 2 , … , N \qquad ( 2 )$$

Signals received by the terminal from a plurality of antennas have the signal strengths (amplitude or power) defined by Equation (3) as follows:

$$\{ \begin{matrix}{I}_{1} = λ & {T}_{1} \\ {I}_{2} = λ & {T}_{2} \\ {I}_{3 } = λ & {T}_{3}\end{matrix} \\ λ \qquad ( 3 )$$

Here, λ is a coefficient that is determined in advance in consideration of the communication environment.

When Equation (2) and Equation (3) above are combined, and T0 and λ are set to 1 in order to easily calculate the equations, the terminal can receive a signal with a signal strength as defined in Equation (4) below, from each of the plurality of antennas, according to the radius of each antenna.

$$\{ \begin{matrix}{I}_{1} = 1 + K sin ( φ ) \\ {I}_{2} = 1 + K sin ( φ + \frac{2 π}{3} ) \\ {I}_{3} = 1 + K sin ( φ + \frac{4 π}{3} )\end{matrix} \qquad ( 4 )$$

When trigonometry is used in Equation (4) above, then Equation (4) can be denoted by Equation (5) and Equation (6) as follows:

$$\begin{matrix}\{ \begin{matrix}{I}_{1} = 1 + K sin ( φ ) \\ {I}_{2} = 1 + K sin ( φ + \frac{2 π}{3} ) = 1 + K ( sin ( φ ) cos ( \frac{2 π}{3} ) + cos ( φ ) sin ( \frac{2 π}{3} ) ) \\ {I}_{3} = 1 + K sin ( φ + \frac{4 π}{3} ) = 1 + K ( sin ( φ ) cos ( \frac{4 π}{3} ) + cos ( φ ) sin ( \frac{4 π}{3} ) )\end{matrix} & ( 5 ) \\ \{ \begin{matrix}{I}_{1} = 1 + K sin ( φ ) \\ {I}_{2} = 1 + K ( - \frac{1}{2} sin ( φ ) + cos ( φ ) ( \frac{\sqrt{3}}{2} ) ) \\ {I}_{3} = 1 + K ( - \frac{1}{2} sin ( φ ) - cos ( φ ) ( \frac{\sqrt{3}}{2} ) )\end{matrix} & ( 6 )\end{matrix}$$

When Equation (6) above is generalized, then Equation (6) can be denoted by Equation (7) as follows:

$${I}_{n} = 1 + K \{ sin ∅cos \frac{2 ( n - 1 ) π}{N} + cos ∅sin \frac{2 ( n - 1 ) π}{N} \} , \\ 0 \leq {I}_{n} \leq 1 \qquad ( 7 )$$

The total of the signal strengths received from a plurality of antennas in accordance with Equation (7) above can be denoted by Equation (8) as follows:

I₂+I₃=2−K sin(φ)

I₁+I₂+I₃=3 (8)

When Equation (8) above is generalized, then Equation (8) can be denoted by Equation (9) as follows:

$${\sum }_{n = 1}^{N} {I}_{n} = N \qquad ( 9 )$$

When a common part from each of I₁ to I₃ estimated by using Equation (6) above is removed, then Equation (6) can be denoted by Equation (10) as follows:

$$\{ \begin{matrix}{I}_{1 , ac}^{′} = K sin ( φ ) \\ {I}_{2 , ac}^{′} = K ( - \frac{1}{2} sin ( φ ) + cos ( φ ) ( \frac{\sqrt{3}}{2} ) ) \\ {I}_{3 , ac}^{′} = K ( - \frac{1}{2} sin ( φ ) - cos ( φ ) ( \frac{\sqrt{3}}{2} ) )\end{matrix} \qquad ( 10 )$$

Further, in Equation (10) above, when respective I_{1,ac}′ to I_{3,ac}′ are divided by K, then Equation (10) can be denoted by Equation (11) as follows:

$$\{ \begin{matrix}{I}_{1 , ac}^{″} = sin ( φ ) \\ {I}_{2 , ac}^{″} = - \frac{1}{2} sin ( φ ) + cos ( φ ) ( \frac{\sqrt{3}}{2} ) \\ {I}_{3 , ac}^{″} = - \frac{1}{2} sin ( φ ) - cos ( φ ) ( \frac{\sqrt{3}}{2} )\end{matrix} \qquad ( 11 )$$

When Equation (11) above is generalized, then Equation (11) can be denoted by Equation (12) as follows:

$${I}_{n , ac} = \frac{{I}_{n} - 1}{K} = sin ∅cos \frac{2 ( n - 1 ) π}{N} + cos ∅sin \frac{2 ( n - 1 ) π}{N} \qquad ( 12 )$$

The signal strength measurement unit 451 determines I₁″, I₂″, and I₃″ which are calculated from Equation (10) above to be the signal levels for respective antennas.

The position estimation unit 453 determines a direction and distance between the terminal and the AP from the determined signal level, and then estimates the position of the terminal. In this case, a method of estimating the position of the terminal can estimate the position of the terminal by comprehensively utilizing previous position data, MicroElectroMechanical Sensors (MEMS), and the geographical information displayed on the map. That is, the position estimation unit 453 can estimate the direction of the terminal according to the angle (or, a radius) from the reference numeral 500 to the terminal. Thus, the position estimation unit 453 determines the value of angle φ by inferring the following Equation (13) and Equation (14) from Equation (10) above.

$$\begin{matrix}\{ \begin{matrix}{I}_{1}^{″} = sin ( φ ) \\ {I}_{2}^{″} - {I}_{3}^{″} = \sqrt{3} cos ( φ ) \\ {I}_{2}^{″} + {I}_{3}^{″} = - sin ( φ )\end{matrix} & ( 13 ) \\ \{ \begin{matrix}φ = arccos ( \frac{{I}_{2}^{″} - {I}_{3}^{″}}{\sqrt{3}} ) \\ φ = arcsin ( - {I}_{2}^{″} - {I}_{3}^{″} ) \\ φ = arcsin ( - {I}_{1}^{″} )\end{matrix} & ( 14 )\end{matrix}$$

Each of the three equations in Equation (14) above is intended to determine φ, however, in fact, an arc function is calculated within the range of

$$- \frac{π}{2} \leq φ \leq \frac{π}{2}$$

Accordingly, the position estimation unit 453 must determine the sign φ of to estimate a correct direction of the terminal. A method of determining the above sign is shown in FIGS. 7A to 7C.

FIGS. 7A to 7C are illustrations of calculating, by a position estimation unit 453, a quadrant where a terminal is located, according to an embodiment of the present disclosure.

In an embodiment of the present disclosure, the position estimation unit 453 determines whether the signs of each of the received signals are either 1 or −1, and then estimates an angle. That is, when a trigonometric equation such as Equation (14) above is solved, then a number of solutions are obtained. In order to reduce such solutions to one solution, it is necessary to define an appropriate range. Accordingly, the position estimation unit 453 defines the range and then determines the exact angle by solving Equation (4) above.

Further, the position estimation unit 453 estimates a distance between the terminal and the AP on the basis of the signal levels of the antennas which are calculated by Equation (11) above. The distance estimation techniques that are used in the technical field of the present disclosure can be utilized in the method of estimating the distance between the terminal and the AP. For example, the distance to the AP can be calculated by utilizing the characteristics of the RSSI and the magnitude of the signal received from the current position. In this case, when the position is calculated, a model is created using the experimentally determined value, and then the corresponding distance is estimated.

Finally, the position estimation unit 453 determines the estimated direction and distance to be the position of the terminal.

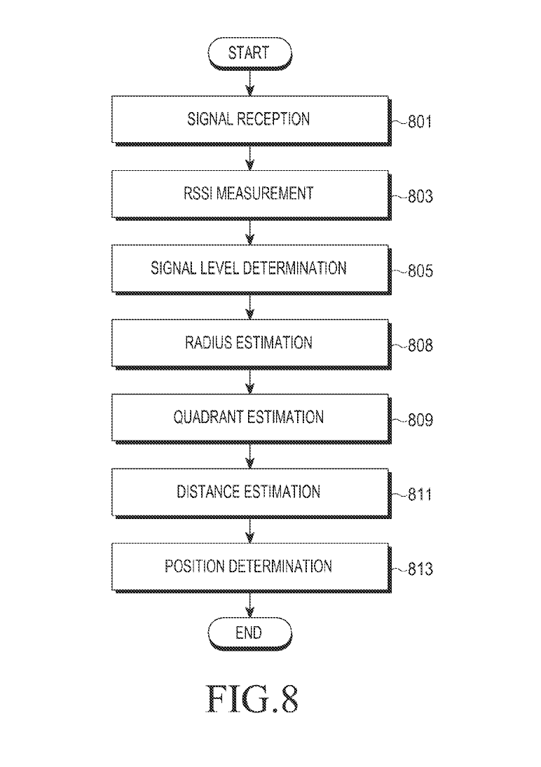

FIG. 8 is a flowchart of a position estimation method by a terminal of the communication system according to an embodiment of the present disclosure.

Referring to FIG. 8, the receiver 410 of the position estimation apparatus receives in step 801 signals for estimating positions transmitted from each of a plurality of antennas which are included in an AP and have radial directions which are different from each other. Then, the controller 450 measures in step 803 the RSSIs of the signals received from each of the plurality of antennas. The controller 450, on the basis of the measured RSSIs, determines in step 805 the signal levels of respective antennas. In this case, the controller 450 can determine the signal level by utilizing Equation (11) above.

The controller 450, on the basis of the determined signal levels at the respective antennas, determines in step 808 an angle (or, a radius) from the AP to the terminal. In this case, the controller 450 determines the value of an angle (e.g. PHI) by inferring Equation (13) and Equation (14) from Equation (11) above. Further, the controller 450, in order to estimate the correct direction of the terminal, on the basis of the determined signal levels, determines in step 809 the quadrant in which the terminal is located. That is, the controller 450 determines the sign of the determined angle.

Thereafter, the controller 450, on the basis of the determined signal levels, estimates in step 811 the distance from the AP to the terminal. Accordingly, the controller 450 estimates the direction of the terminal using the determined angle and sign, and finally determines in step 813 the estimated direction and distance to be the position of the terminal.

Therefore, the position estimation apparatus according to an embodiment of the present disclosure, even in a case where an AP includes a plurality of antennas, can precisely estimate the position of the terminal, on the basis of the relative signal levels being transmitted between each of the plurality of antennas which have radial directions which are different from each other.

While the present disclosure has been shown and described with reference to certain embodiments thereof, it will be understood by those skilled in the art that various changes in form and details may be made therein without departing from the scope and spirit of the present disclosure. Thus, the scope of the present disclosure shall not be determined merely based on the described embodiments but rather shall be determined based on the scope of the present disclosure, as defined by the appended claims and the equivalents.

What is claimed is:

1. An apparatus for estimating a position of a terminal in a communication system, the apparatus comprising:
a receiver configured to receive signals transmitted from two or more antennas which are included in an access point (AP) and have radial directions which are different from each other; and
a controller configured to determine signal levels with respect to the respective two or more antennas from signal strength values of signals which are distinguished by the received radial directions which are different from each other, estimate a direction and distance between the AP and the terminal on the basis of the determined signal levels, and determine the position of the terminal from the estimated direction and distance.

2. The apparatus of claim 1, wherein the determined signal levels are determined by a relative difference between the signal strength values of the signals which are distinguished by the received radial directions which are different from each other.

3. The apparatus of claim 1, wherein the determined signal levels are determined by relative values of angles of the two or more antennas, respectively.

4. The apparatus of claim 3, wherein the controller is further configured to combine the determined signal levels to estimate an angle between the AP and the terminal, and estimate the direction from the estimated angle.

5. The apparatus of claim 4, wherein the controller, at the estimated angle, is further configured to estimate a distance between the AP and the terminal according to a size of the received signals.

6. The apparatus of claim 1, wherein the controller is further configured to estimate the distance by combining the determined signal levels.

7. The apparatus of claim 1, wherein the respective two or more antennas indicate a diagram having directivity angles different from each other.

8. A method of estimating a position of a terminal in a communication system, the method comprising:
receiving signals transmitted from two or more antennas which are included in an access point (AP) and have radial directions which are different from each other;
determining signal levels with respect to the respective two or more antennas from signal strength values of the signals which are distinguished by the received radial directions which are different from each other;
estimating a direction and distance between the AP and the terminal based on the determined signal levels; and
determining the position of the terminal from the estimated direction and distance.

9. The method of claim 8, wherein the determined signal levels are determined by a relative difference between the signal strength values of the signals which are distinguished by the received radial directions which are different from each other.

10. The method of claim 8, wherein determining signal levels further comprises determining by relative values of angles of the two or more antennas, respectively.

11. The method of claim 10, wherein estimating a direction and distance between the AP and the terminal based on the determined signal levels comprises estimating an angle between the AP and the terminal by combining the determined signal levels, and estimating the direction from the estimated angle.

12. The method of claim 11, further comprising estimating, at the estimated angle, a distance between the AP and the terminal according to a size of the received signals.

13. The method of claim 8, wherein estimating a direction and distance between the AP and the terminal based on the determined signal levels comprises estimating the distance by combining the determined signal levels.

14. The method of claim 8, wherein the respective two or more antennas indicate a diagram having directivity angles different from each other.

15. A chipset for estimating a position of a terminal in a communication system configured to:
receive signals transmitted from two or more antennas which are included in an Access Point (AP) and have radial directions which are different from each other;
determine signal levels with respect to the respective two or more antennas from signal strength values of the signals which are distinguished by the received radial directions which are different from each other;
estimate a direction and distance between the AP and the terminal based on the determined signal levels; and
determine the position of the terminal from the estimated direction and distance.

16. The chipset of claim 15, wherein the determined signal levels are determined by a relative difference between the signal strength values of the signals which are distinguished by the received radial directions which are different from each other.

17. The chipset of claim 15, wherein the determined signal levels are determined by relative values of angles of the two or more antennas, respectively.

18. The chipset of claim 17, wherein the chipset is further configured to combine the determined signal levels to estimate an angle between the AP and the terminal, and estimate the direction from the estimated angle.

19. The chipset of claim 18, wherein the chipset, at the estimated angle, is further configured to estimate a distance between the AP and the terminal according to a size of the received signals.

20. The chipset of claim 15, wherein the respective two or more antennas indicate a diagram having directivity angles different from each other.
